(19) United States
(12) Patent Application Publication
(10) Pub. No.: US 2026/0270314 A1
(43) Pub. Date: Sep. 10, 2026

(54) END-TO-END SECURE MESSAGING FOR INDUSTRIAL AUTOMATION ENVIRONMENTS

(71) Applicant: Rockwell Automation Technologies, Inc., Mayfield Heights, OH (US)

(72) Inventors: Todd A. Wiese, Hubertus, WI (US); Jack M. Visoky, Willoughby, OH (US); Jakub Korbel, Praha (CZ); Marius G. Chis, Cambridge (CA)

(21) Appl. No.: 19/344,772

(22) Filed: Sep. 30, 2025

Related U.S. Application Data
(60) Provisional application No. 63/767,861, filed on Mar. 6, 2025.

(51) Int. Cl. H04L 67/133; G05B 19/418; H04L 9/08

(52) U.S. Cl. CPC H04L 67/133; G05B 19/4186; H04L 9/0822

(57) ABSTRACT

A method includes a client device establishing a first data link with a human interface module (HIM) device in an industrial automation environment. The client device instructs the HIM device to create a socket and to connect the socket to an automation device in the industrial automation environment, the automation device being connected to the HIM device by a second data link, and to forward session setup messages for a secure session over the second data link to the automation device. The client device may then secure operational messages associated with an industrial communication protocol using a key associated with the secure session, thereby generating secure messages. The client device instructs the HIM device, via the first data link, to forward the secure messages over the second data link to the socket on the automation device.

### RELATED APPLICATIONS

This application is related to – and claims the benefit of priority to – U.S. Provisional Patent Application No. 63/767,861, filed on March 6, 2025, and entitled “Transferring Secure CIP Messaging Through a Bluetooth (BLE) Transport,” which is hereby incorporated by reference in its entirety and for all purposes.

### TECHNICAL FIELD

Aspects of the disclosure are related to the field of industrial automation solutions and in particular to systems, methods, and software for providing secure communications between and/or amongst elements in an industrial automation environment.

### BACKGROUND

Industrial automation systems commonly employ layered communication architectures in which user devices interact with field-level equipment such as drives through intermediary modules. These systems often rely on Bluetooth Low Energy (BLE) for wireless connectivity between mobile user devices and Human Interface Modules (HIMs), while HIMs themselves connect to industrial drives or other such industrial automation devices via USB, Ethernet, or through Ethernet switches. Although this modular approach offers flexibility and ease of deployment, it introduces challenges in maintaining secure and consistent communication across the full path.

In conventional implementations, Transport Layer Security (TLS) is used to secure data between directly connected devices. However, when communication is routed through intermediary modules such as HIMs, TLS sessions are typically terminated at the intermediary, leaving protocol-layer messages exposed during transit. This partial encryption model undermines the confidentiality and/or integrity of control data and creates vulnerabilities in environments where secure operation is critical.

Furthermore, existing solutions often require custom firmware modifications to intermediary devices or rely on proprietary tunneling mechanisms that complicate interoperability and scalability. There is a need for a system that enables true end-to-end encryption of messages between a user device and an industrial automation device, even when routed through a HIM.

### SUMMARY

Technology disclosed herein accomplishes end-to-end protection in an industrial automation environment by way of remote procedure call (RPC) messaging by a device that directs an intermediate device to open a socket on a destination device. The initiating device may then utilize the socket to establish a secure session with the destination device. The intermediate device thus functions as a proxy for the initiating device, allowing it and the destination device to exchange encrypted communications.

In one implementation, a method includes a client device establishing a first data link with a human interface module (HIM) device in an industrial automation environment. The client device instructs the HIM device to create a socket and to connect the socket to an automation device in the industrial automation environment. As the automation device is connected to the HIM device by a second data link, the client device also instructs the HIM to forward session setup messages for a secure session over the second data link to the automation device. The client device may then secure operational messages associated with an industrial communication protocol using a key associated with the secure session (e.g., a TLS session), thereby generating secure messages. The client device instructs the HIM device, via the first data link, to forward the secure messages over the second data link to the socket on the automation device.

In another implementation, an intermediate device establishes a first data link with an end-point in the industrial automation environment. The intermediate device establishes a second data link with a automation device in the industrial automation environment. The intermediate device receives a first remote procedure call (RPC) message over the first data link from the end-point, wherein the message includes a request to establish a secure session with the automation device and an instruction to forward the request. In response, the intermediate device sends the request over the second data link to the automation device. The intermediate device then receives a second RPC message over the first data link from the end-point, wherein the message includes an operational message encrypted using a cryptographic key associated with the secure session and an instruction to forward the message to the automation device on a socket associated with the secure session. The intermediate device responsively sends the encrypted operational message over the second data link to the specified socket.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an industrial automation environment in an implementation.

FIG. 2 illustrates an industrial automation process in an implementation.

FIG. 3 illustrates an operational scenario in an implementation.

FIG. 4 illustrates an industrial automation environment in an implementation.

FIG. 5 illustrates an operational scenario in an implementation.

FIG. 6 illustrates an operational scenario in an implementation.

FIG. 7 illustrates a computing system suitable for implementing the various operational environments, architectures, processes, scenarios, and sequences discussed below with respect to the other Figures.

### DETAILED DESCRIPTION

The disclosed technology relates to secure communication in distributed control environments, specifically enabling end-to-end protection of protocol-layer messages between a first device and a destination device via an intermediate device. In one embodiment, the first device establishes a wireless connection with the intermediate device using a short-range communication protocol. The intermediate device serves as a communication bridge and is physically connected to the destination device through one or more transport interfaces.

To facilitate secure transmission of control messages, the disclosed technology employs a combination of remote invocation mechanisms and encrypted transport protocols. The process begins with the first device issuing a remote instruction to the intermediate device, directing it to establish a socket-based connection to a network-accessible layer of the destination device. Once the connection is established, the first device and destination device(s) initiate a secure handshake over the socket, resulting in an encrypted communication channel between their respective protocol layers.

Following the establishment of the secure session, the first device encrypts control messages at its local transport layer. These secure messages are then encapsulated within remote instructions that instruct the intermediate device to forward the encrypted payload to the previously established connection on the destination device. Upon receipt, the destination device routes the secure messages to its corresponding transport layer for decryption. Once decrypted, the messages are processed by the destination device’s protocol stack as if they were received in plain text.

This architecture enables end-to-end protection of industrial automation traffic (in some cases, using standard, well-established and future-proof technologies), even when intermediary devices are present in the communication path. By leveraging remote invocation as a control mechanism and encrypted transport as a delivery method, the invention ensures the confidentiality and/or integrity of operational messages, compatibility with existing infrastructure, and minimal changes to intermediary firmware or destination protocol implementations.

In a variation, the intermediate device may be coupled to multiple destination devices via a network switch, such as an Ethernet switch. This configuration allows the first device to establish secure, end-to-end encrypted communication sessions with any of the destination devices through the intermediate device. Using remote instructions, the first device can direct the intermediate device to open socket connections to selected destination devices, enabling encrypted transport-layer sessions to be established individually. Once connected, encrypted protocol-layer messages are forwarded by the intermediate device to the appropriate destination device, where they are decrypted and processed as described above.

Specific embodiments enable end-to-end protection of CIP (Common Industrial Protocol) messages between a user device and an industrial drive via a Human Interface Module (HIM). In one embodiment, a user device operating within such an environment establishes a wireless connection with a HIM using Bluetooth Low Energy (BLE). The HIM serves as a communication bridge and is physically connected to an industrial drive or other such automation device(s) via USB, Ethernet, or a USB-to-Ethernet adapter.

To facilitate secure transmission of CIP messages, the invention employs a novel combination of Remote Procedure Call (RPC) messaging and Transport Layer Security (TLS) tunneling. The process includes an application on the user device making a connect call to a network interface on the user device (an example of which is the Berkeley Software Development Socket API – or BSD socket API – which may be modified to operate as described herein). The network interface layer responsively encapsulates the call and/or parameters of the call in an RPC instruction, which the user device sends to the HIM. The RPC instruction directs the HIM to create a socket based on one or more of the parameters of the call and to connect the socket to the automation device. The socket may be associated with the EtherNet/IP layer of the automation device in some examples. Once the socket is established, the user device and the automation device initiate a TLS handshake directly over this connection, resulting in a secure, encrypted channel between their respective CIP layers.

Following the establishment of the TLS session, the user device encrypts CIP messages at its local TLS layer and encapsulates the CIP messages in EtherNet/IP. These secure messages are then encapsulated within RPC instructions that instruct the HIM to forward the encrypted payload to the previously opened socket on the automation device. This occurs by the application making send and sendto calls to the network interface layer (e.g., BSD socket API), which results in the creation of the RPC instructions. Upon receipt, the automation device routes the encrypted CIP messages to its internal TLS layer for decryption. Once decrypted, the EtherNet/IP-encapsulated CIP messages are processed by the automation device’s EtherNet/IP-CIP stack.

This architecture enables end-to-end protection of CIP traffic in a manner that is transparent to developers, even when intermediary devices such as HIMs are involved. By leveraging RPC as a control mechanism and TLS as a transport layer, the invention ensures confidentiality of industrial control messages, compatibility with existing EtherNet/IP infrastructure, and minimal changes to HIM firmware or automation device protocol stacks.

In a variation of the invention, the Human Interface Module (HIM) may be connected to multiple industrial automation devices via an Ethernet switch. This configuration allows the user device to establish secure, end-to-end encrypted communication sessions with any of the connected automation devices through the HIM. The user device, which connects to the HIM over Bluetooth Low Energy (BLE), uses Remote Procedure Call (RPC) messages to instruct the HIM to open socket connections to the EtherNet/IP layer of selected automation devices. Once a socket is connected to a particular automation device, the user device and that automation device perform a TLS handshake to establish a secure channel. The user device then encapsulates the Common Industrial Protocol (CIP) messages in EtherNet/IP, encrypts the encapsulated messages at its TLS layer, and sends them to the HIM via RPC. The HIM forwards the encrypted messages to the appropriate automation device over USB, Ethernet, or through the Ethernet switch. Each automation device receives the secure messages, decrypts them at its TLS layer, and processes the resulting CIP payloads as if they were received directly. This architecture enables the user device to securely communicate with multiple automation devices using a single HIM, while maintaining end-to-end protection of CIP traffic across the entire communication path.

In some applications, protection at the transport layer may not be required due to the presence of a trusted, isolated network environment or the absence of sensitive control data. In such cases, the user device can still utilize Remote Procedure Call (RPC) messages to facilitate the exchange of Common Industrial Protocol (CIP) messages (encapsulated in EtherNet/IP) with an industrial automation device through a Human Interface Module (HIM), without establishing a TLS session. The user device connects to the HIM over Bluetooth Low Energy (BLE) and sends RPC instructions directing the HIM to create a socket connection to the EtherNet/IP layer of the automation device. Once the socket is established, the user device transmits CIP messages unencrypted (but encapsulated within EtherNet/IP), encapsulated within RPC calls to the HIM. The HIM forwards these CIP messages over USB, Ethernet, or via an Ethernet switch to the automation device. Upon receipt, the automation device processes the encapsulated CIP messages directly through its protocol stack. This configuration maintains the architectural benefits of centralized control and flexible routing via the HIM, while omitting the overhead of protection in environments where it is deemed unnecessary.

While the technology has been described primarily in the context of a user device communicating with industrial automation devices via a Human Interface Module (HIM), the underlying architecture is broadly applicable across many domains. The user device, for example, could be a mobile maintenance tablet in a smart building, a wearable used by field technicians in an energy grid, a laptop running diagnostic software for medical imaging systems, a drone controller managing autonomous inspection routines, or a handheld scanner used in warehouse logistics. Similarly, the intermediate device need not be limited to a HIM. For instance, the HIM could be a gateway module in a smart factory, a telematics unit in a vehicle, a medical device hub aggregating diagnostic inputs, a sensor concentrator in environmental monitoring, or a retail point-of-sale terminal routing encrypted data. The destination device, which receives and processes the control or data messages, could be a programmable logic controller managing robotic arms, a smart HVAC controller, a high-resolution imaging system, a telemetry unit on a remote oil rig, or a backend processor in a secure financial network. These examples illustrate the versatility of the invention’s architecture, which enables secure, end-to-end communication across diverse systems using remote invocation and encrypted transport mechanisms.

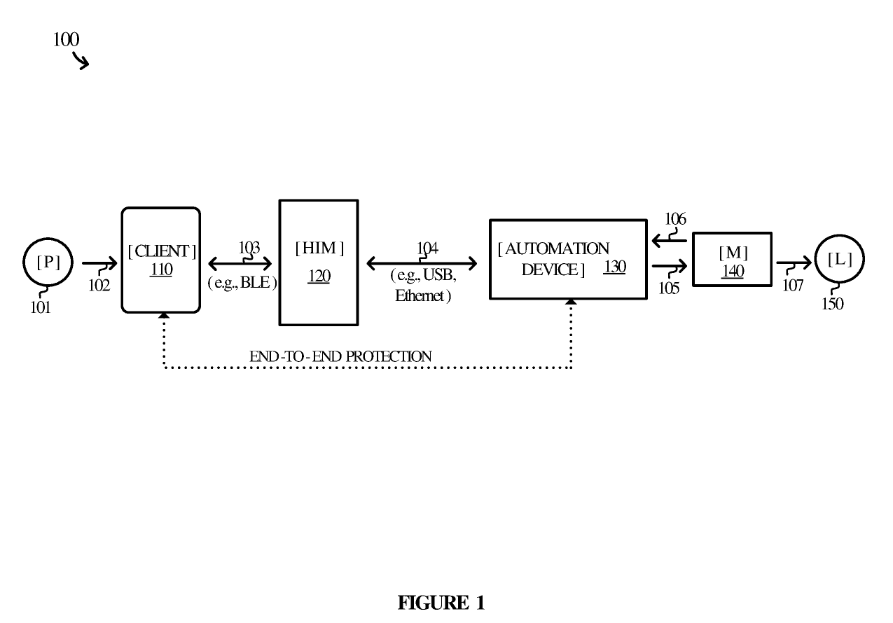

Turning now to the drawings, FIG. 1 illustrates an exemplary industrial automation environment 100. Industrial automation environment 100 includes user device 110, HIM 120, automation device 130, human operator 101, motor 140, and load 150. Industrial automation environment 100 provides a structured framework for initiating, relaying, and executing control operations within an industrial system. Each element within industrial automation environment 100 plays a distinct role in facilitating communication, control, and actuation across the automation hierarchy.

Human operator 101 represents an individual who interacts with industrial automation environment 100 to initiate or monitor system operations. Human operator 101 may engage with user device 110 to input commands, configure parameters, or observe system feedback. In certain embodiments, human operator 101 may also interact directly with HIM 120, for example, to perform localized diagnostics, initiate manual overrides, or adjust interface settings.

User device 110 represents any client device capable of interfacing with HIM 120. Examples of user device 110 include, but are not limited to, workstations, tablets, smartphones, embedded control panels, or cloud-based control terminals. User device 110 serves as the origin point for operator input, system configuration, and monitoring functions. User device 110 is communicatively coupled to HIM 120 via data link 103. Data link 103 may be implemented using Bluetooth Low Energy (BLE), enabling wireless transmission of control data and configuration parameters between user device 110 and HIM 120.

HIM 120 corresponds to any intermediate device configured to bridge communication between user device 110 and automation device 130. HIM 120 may include Human Interface Modules, protocol converters, gateway devices, or embedded relay controllers. HIM 120 may perform protocol translation, data validation, buffering, or limited control logic to ensure reliable transmission of commands. HIM 120 is communicatively coupled to automation device 130 via data link 104. Data link 104 may be implemented using USB, Ethernet, or a combination thereof, such as a USB-to-Ethernet adapter or converter, depending on the interface requirements of automation device 130.

Automation device 130 represents any destination device suitable for receiving and executing control instructions within industrial automation environment 100. Examples of automation device 130 include but are not limited to motor control units such as variable frequency drives and servo drives, programmable logic controllers (PLCs), process control devices, I/O devices, safety devices, and the like. Automation device 130 functions as the execution endpoint for operational instructions received via HIM 120. Automation device 130 directly controls motor 140, which may include electromechanical components such as rotary or linear actuators. Motor 140, in turn, actuates load 150, which represents the physical system or process being influenced—such as a conveyor belt, pump, robotic arm, or other industrial mechanism.

User device 110, HIM 120, and automation device 130 are communicatively coupled in a sequential arrangement via data links 103 and 104, enabling modular and scalable deployment across various industrial applications. Communication between user device 110, HIM 120, and automation device 130 may be facilitated using a combination of wireless and wired protocols, allowing flexible integration into diverse automation environments. The inclusion of human operator 101, motor 140, and load 150 further contextualizes industrial automation environment 100 as a complete control loop, encompassing user interaction, signal processing, actuation, and physical output.

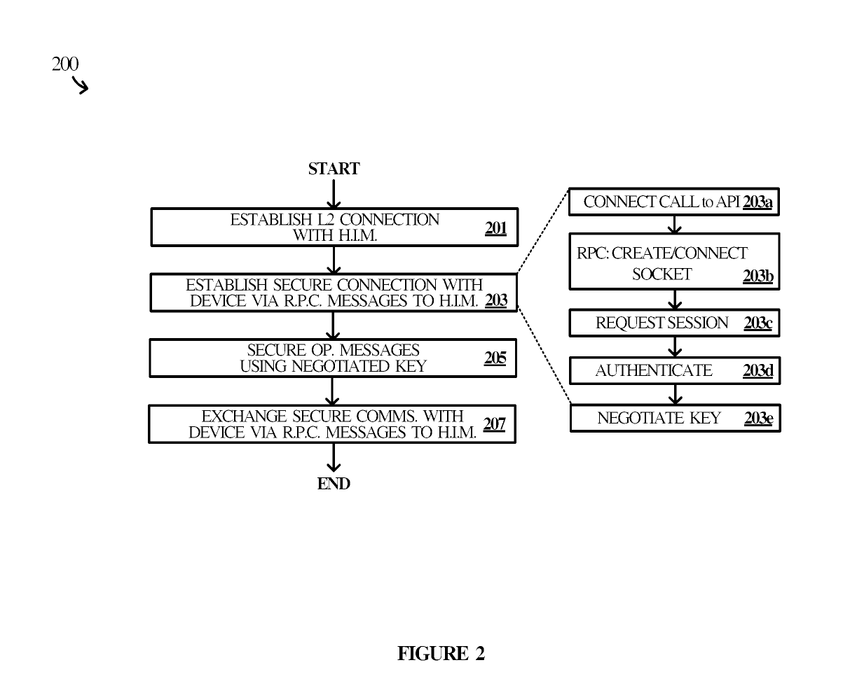

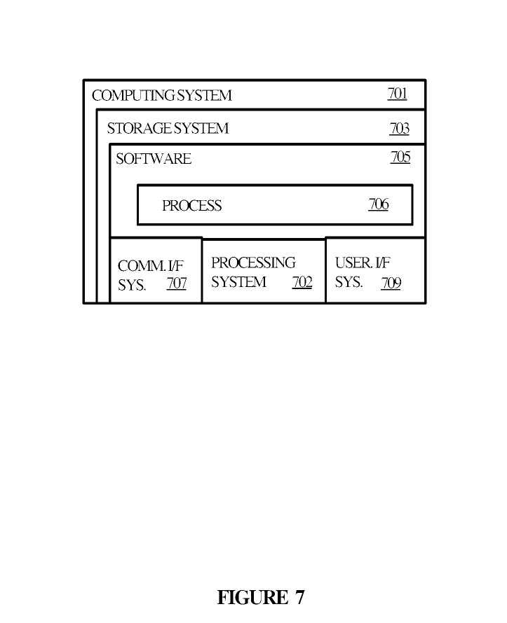

FIG. 2 illustrates process 200, which may be executed by a client device within an industrial automation context. Process 200 enables secure and structured communication between the client device and a destination device, such as a drive or other control endpoint, via an intermediate device. Process 200 may be implemented in program instructions in the context of the software and/or firmware elements of a device (or devices) having a suitable computing architecture, of which the computing device in FIG. 7 is representative. The program instructions, when executed by one or more processing devices of one or more suitable computing devices, direct the one or more computing devices to operate as follows, referring to the steps of FIG. 2 (Steps 201, 203, 205, and 207), each contributing to the establishment and use of a secure operational messaging channel.

Step 201 of process 200 involves establishing a data link or other layer-2 connection between the client device and the intermediate device. This connection may be implemented using technologies such as Bluetooth Low Energy (BLE), Wi-Fi Direct, or other peer-to-peer protocols that support low-latency and reliable communication. The layer-2 connection formed in step 201 provides the foundational transport mechanism for subsequent message exchanges.

Step 203 of process 200 involves establishing a secure connection between the client device and the destination device. This secure connection is facilitated through remote procedure call (RPC) messages transmitted to the destination device via the intermediate device. During this step, the client device may initiate a handshake protocol, negotiate cryptographic parameters, and validate the identity of the destination device to ensure that subsequent communications are protected against unauthorized access or tampering.

More specifically, Step 203 includes various sub-steps: Steps 203a-203e. The sub-steps of process 200 involves creating a socket and connecting the socket to the destination device. This action is initiated at Step 203a by an application on the client device making a connect call to a network interface layer on the client device requesting the network interface layer to establish a socket connection with the destination device. At Step 203b, the network interface layer reacts to the connect call by generating and transmitting a remote procedure call (RPC) message to the intermediate device instructing it to create a socket connection with the destination device. Upon receiving the instruction, the intermediate device establishes the socket, thereby creating a transport channel between the intermediate device and the destination device. This socket serves as the conduit for subsequent secure session negotiation, although the destination device perceives the intermediate device as the initiating endpoint.

Step 203c of process 200 involves requesting a secure session over the socket established in Steps 203a and 203b. This may again be initiated by the application on the client device making a send call to the network interface layer of the device that includes a request and/or parameters of a request to establish the secure session. The network interface layer of the device reacts to the send call by generating and sending an RPC message to the intermediate device, which relays the secure session request to the destination device over the socket. In response, the destination device begins a handshake process that it believes is occurring with the intermediate device. However, the handshake messages are transparently forwarded between the destination device and the client device, allowing the client device to act as the endpoint of the secure session without the destination device being aware of the abstraction.

Step 203d of process 200 involves authentication between the client device and the destination device. As part of the handshake initiated in step 203c, the destination device and client device exchange authentication credentials, such as digital certificates, tokens, or challenge-response pairs. These credentials are routed through the intermediate device, which acts as a passive relay. The authentication process confirms the identity of the client device to the destination device, even though the destination device continues to operate under the assumption that it is authenticating the intermediate device.

Step 203e of process 200 involves negotiating a cryptographic key between the client device and the destination device. Following successful authentication in step 203c, the client device and destination device engage in a key exchange protocol to derive a shared cryptographic key. This key is used to secure operational messages in subsequent steps of process 200. The key negotiation messages are routed through the intermediate device, which does not participate in the cryptographic exchange and remains unaware of the final key material. As a result, the secure session is effectively established between the client device and the destination device, despite the destination device perceiving the intermediate device as the session peer.

Step 205 of process 200 involves encrypting operational messages using a cryptographic key negotiated during the secure connection setup in step 203. The encryption process may utilize symmetric or asymmetric algorithms, depending on the implementation, and ensures that control commands, configuration data, and other sensitive information are protected during transmission. By encrypting operational messages, the client device enhances the confidentiality and integrity of communications with the destination device.

Step 207 of process 200 involves exchanging the encrypted operational messages with the destination device. These messages are transmitted via RPC calls routed through the intermediate device, which may relay the encrypted payloads without modification or perform protocol-specific encapsulation to ensure compatibility. The message exchange in step 207 enables the client device to execute control operations, monitor system status, and maintain synchronized interaction with the destination device in a secure and structured manner.

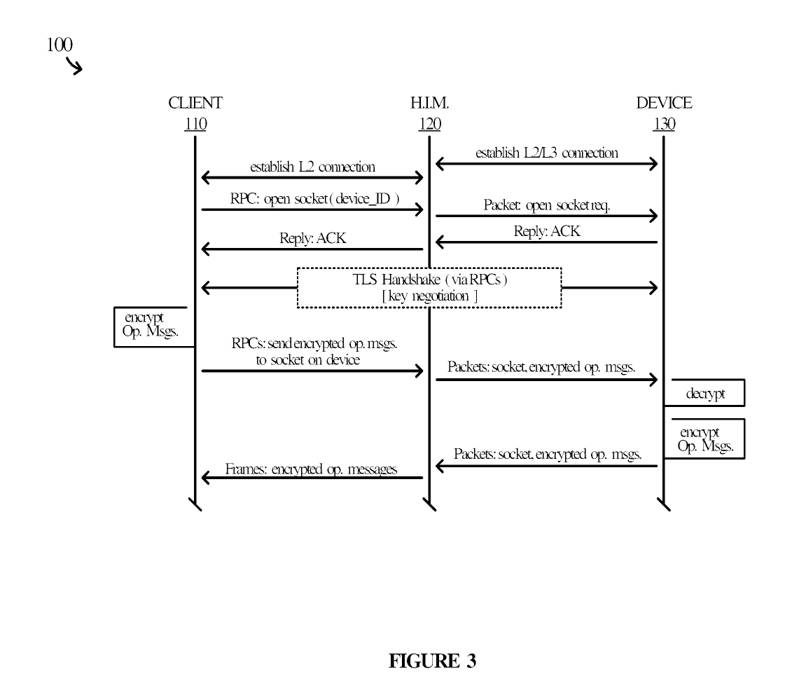

FIG. 3 illustrates operational sequence 300, which illustrates an application of process 200 to the elements of FIG. 1 – namely user device 110, human interface module (HIM) 120, and automation device 130. This sequence shows how a layered architecture enables end-to-end confidentiality and integrity, even when intermediary devices are involved.

The sequence begins when user device 110 initiates a wireless connection with HIM 120 over data link 103. This link is typically implemented using Bluetooth Low Energy (BLE), allowing for low-power, short-range communication. BLE is particularly well-suited for industrial environments where mobility and ease of pairing are important. By establishing this link, user device 110 gains access to HIM 120’s interface and can begin issuing remote procedure calls (RPCs) to control or configure downstream components.

Once the BLE connection is active, user device 110 sends an RPC command instructing HIM 120 to open a socket connection with automation device 130. As mentioned, the RPC command may be generated by a network interface layer of user device 110 in response to a connect call by an application on user device 110. HIM 120 responds by initiating the socket over data link 104, which may be implemented using USB, Ethernet, or a USB-to-Ethernet adapter, depending on the physical setup. This socket acts as a transport tunnel, allowing HIM 120 to forward messages between user device 110 and automation device 130 without interpreting or modifying their contents. HIM 120 essentially becomes a transparent relay between the two endpoints.

With the socket in place, user device 110 requests HIM 120 to initiate a secure session with automation device 130. HIM 120 forwards this request, and automation device 130 begins a TLS handshake, believing it (automation device 130) is communicating directly with HIM 120. However, HIM 120 simply passes the handshake messages back and forth between automation device 130 and user device 110. This relay mechanism allows user device 110 and automation device 130 to perform mutual authentication and negotiate encryption keys, while HIM 120 remains unaware of the session contents. This design ensures that only the endpoints – user device 110 and automation device 130 – have access to the decrypted payloads.

During the handshake, user device 110 and automation device 130 exchange credentials, such as certificates, public keys, or authentication tokens, to verify each other’s identities. Once authenticated, they negotiate a session key using a secure key exchange protocol. This key is used to secure all subsequent communications, ensuring that operational messages cannot be intercepted or tampered with by intermediate devices or unauthorized actors.

With the secure session established, user device 110 begins encrypting operational messages using the negotiated session key. These messages may include automation device configuration commands, parameter updates, or status queries. Each encrypted payload is wrapped in an RPC message and sent to HIM 120, which forwards it to automation device 130 over the socket. Automation device 130 receives the encrypted message, decrypts it using its TLS layer, and processes the resulting CIP (Common Industrial Protocol) payload through its control stack. This allows automation device 130 to execute commands or return status information without ever exposing the raw data to HIM 120.

Once the secure channel is active, CIP messages can be exchanged seamlessly. For example, user device 110 might send a Set Attribute Single message to configure a specific parameter on automation device 130, such as motor speed or acceleration ramp time. The message is encrypted, forwarded by HIM 120, and decrypted by automation device 130, which then applies the configuration. Conversely, user device 110 might issue a Get Attribute All request to retrieve the current status of the automation device, including fault codes, operating temperature, or runtime metrics. Automation device 130 responds with an encrypted CIP reply, which is relayed back through HIM 120 to user device 110, where it is decrypted and displayed to the operator.

This architecture enables secure, flexible control of industrial devices from mobile platforms, without requiring HIM 120 to act as a trusted endpoint. It preserves protocol integrity, supports dynamic configuration, and allows for real-time diagnostics—all while maintaining end-to-end protection between the user and the automation device.

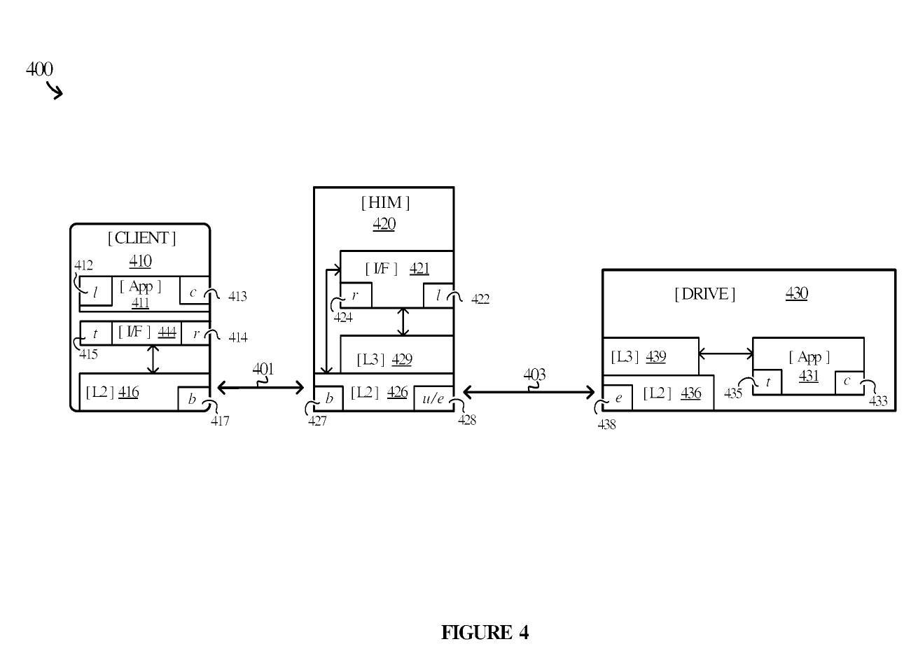

FIG. 4 illustrates another industrial automation environment in an implementation. Industrial automation environment 400 includes three primary components: client device 410, human interface module (HIM) 420, and drive 430. This environment represents a flexible and modular architecture designed to facilitate secure communication and control within an industrial setting.

Client device 410 is a portable computing platform operated by a technician, engineer, or system administrator. Client device 410 may take the form of a smartphone, tablet, laptop, or specialized handheld controller. Client device 410 typically runs a user-facing application that enables configuration, diagnostics, and control of industrial components. Through this interface, client device 410 initiates communication with HIM 420 and interacts with drive 430 using structured messaging protocols. The application also supports secure session establishment, encryption, and remote procedure call (RPC) capabilities.

HIM 420 serves as a physical and logical bridge between client device 410 and drive 430. Often mounted directly on or near the drive, HIM 420 may include a display, keypad, or touch interface for local control. HIM 420 supports multiple communication protocols and physical interfaces, allowing it to relay messages between wireless and wired systems. In this configuration, HIM 420 connects wirelessly to client device 410 and physically to drive 430, acting as a transparent relay for encrypted or structured messages. Depending on its implementation, HIM 420 may also perform auxiliary functions such as protocol translation, power conversion, or session management.

Drive 430 is an industrial motor drive or actuator controller responsible for executing motion commands, regulating power delivery, and reporting operational status. Drive 420 typically includes a control stack capable of parsing Common Industrial Protocol (CIP) messages and executing corresponding actions. Drive 430 may support secure communication protocols such as TLS and is designed to operate within a broader automation system. Drive 430 receives commands and configuration data from client device 410, routed through HIM 420, and responds with status updates or diagnostic information.

Communication between client device 410 and HIM 420 occurs over data link 401, which is typically implemented using Bluetooth Low Energy (BLE). BLE provides low-power, short-range connectivity ideal for mobile diagnostics and configuration tasks. This wireless link allows client device 410 to initiate RPCs, request secure sessions, and transmit encrypted payloads to HIM 420 without requiring a physical connection. HIM 420 then communicates with drive 430 over data link 403, which may use USB, Ethernet, or a hybrid configuration involving adapters or converters. This physical link supports high-throughput, low-latency data exchange and serves as the transport layer for messages relayed from client device 410.

Together, these components form a robust and adaptable communication framework that enables secure, remote interaction with industrial drive systems. The architecture supports dynamic configuration, real-time diagnostics, and encrypted control messaging, all while maintaining protocol integrity across heterogeneous interfaces.

Client device 410 includes an application 411, a datalink layer 416, and an interface layer 444, each comprising distinct functional components that work together to enable secure, protocol-compliant communication with industrial devices. Application 411 represents a user-facing application capable of calling interface layer 444 to access data link layer 416. An example of interface layer 444 is the BSD socket API. . Application 411 includes business logic 412, which governs the high-level behavior of the application. This component interprets user inputs, manages workflows, and determines which control or diagnostic actions to perform based on operational context. Business logic 412 serves as the decision-making layer that drives interactions with downstream devices.

Supporting the business logic in application 411 is CIP engine 413, which constructs and parses messages conforming to the Common Industrial Protocol (CIP) and EtherNet/IP. CIP engine 413 translates business-level commands into CIP-compliant payloads and decodes responses from drive 430, enabling compatibility with a wide range of industrial automation systems. RPC manager 414 in application interface 444 handles the encapsulation and routing of remote procedure calls between client device 410 and HIM 420. RPC manager 414 packages CIP payloads (encapsulated in EtherNet/IP) into RPC messages, manages session state, and coordinates message delivery over the BLE link, ensuring reliable and ordered communication. To secure these interactions, TLS module 415 establishes and maintains encrypted sessions using Transport Layer Security. TLS module 415 performs mutual authentication with drive 430, negotiates cryptographic keys, and encrypts outbound messages while decrypting incoming ones, enabling end-to-end confidentiality and integrity. While shown as implemented by interface layer 444, TLS module 415 may be implemented by application 411 or some other software component on client device 410.

Complementing application 411 and interface layer 444 is datalink layer 416, which provides the physical and protocol-level interface for wireless communication. Datalink layer 416 includes a BLE interface 417, which implements Bluetooth Low Energy connectivity. BLE interface 417 handles device discovery, pairing, and data transmission between client device 410 and HIM 420. BLE interface 417 supports L2CAP COC operations and may expose custom services for RPC messaging, ensuring that encrypted payloads generated by TLS module 415 are transmitted securely and efficiently. Together, application 411, API 444, and datalink layer 416 form a cohesive architecture that enables client device 410 to securely and intelligently interact with industrial components in environment 400.

HIM 420 includes interface layer 421, datalink layer 426, and network layer 429, each serving a distinct role in facilitating communication between client device 410 and drive 430. Interface layer 421 is the software layer responsible for managing message flow and local control logic. Within this layer, RPC manager 424 handles the reception and forwarding of remote procedure calls originating from client device 410. RPC manager 424 acts as a conduit, relaying structured messages without interpreting or modifying their contents, thereby supporting transparent communication between endpoints. Alongside RPC manager 424, business logic 422 governs any local operations that HIM 420 may perform independently, such as interface interactions, status monitoring, or fallback behaviors. Business logic 422 may also manage device pairing, session initiation routines, or diagnostic feedback relevant to the operation of HIM 420 more generally.

Datalink layer 426 provides the physical and protocol-level interfaces that connect HIM 420 to both client device 410 and drive 430. Datalink layer 426 includes BLE interface 427, which enables wireless communication with client device 410 using Bluetooth Low Energy. BLE interface 427 supports device discovery, pairing, and data exchange, allowing HIM 420 to receive RPC messages and forward them downstream. Also included is network interface 428, which facilitates physical connectivity to drive 430. Depending on the deployment, network interface 428 may support USB, Ethernet, or a hybrid configuration involving adapters or converters. Network interface 428 ensures reliable, high-throughput transport of encrypted payloads and CIP messages between HIM 420 and drive 430.

Network layer 429 operates above the datalink layer and manages socket-level communication with drive 430. Network layer 429 establishes and maintains the transport channel on which secure messages are exchanged. This layer may handle socket creation, connection state, and message framing, enabling HIM 420 to forward payloads from client device 410 to drive 430 without terminating or decrypting the secure session. By abstracting the transport mechanics, network layer 429 allows HIM 420 to serve as a flexible relay across heterogeneous physical interfaces.

Drive 430 includes application 431, datalink layer 436, and network layer 439, each contributing to its role as a secure, protocol-compliant actuator controller within the industrial automation environment. Application 431 represents the software stack responsible for interpreting secure messages, executing control logic, and interfacing with the drive’s hardware control systems. Within this layer, TLS module 435 manages secure communication by terminating Transport Layer Security sessions initiated by client device 410. TLS module 435 performs mutual authentication, negotiates cryptographic keys, and decrypts incoming messages while encrypting outbound responses. This ensures that all operational data exchanged with the client remains confidential and tamper-proof. Complementing TLS module 435 is CIP engine 433, which parses and processes messages formatted according to the Common Industrial Protocol. CIP engine 433 interprets service codes, attribute requests, and data payloads, enabling the drive to execute commands such as parameter updates, status queries, and motion control instructions.

Datalink layer 436 provides the physical interface for communication between drive 430 and HIM 420. Datalink layer 436 includes Ethernet interface 438, which supports high-speed, low-latency data exchange over standard industrial networks. Ethernet interface 438 may be configured for direct Ethernet connectivity or may operate through a USB-to-Ethernet adapter, depending on the system architecture. Ethernet interface 438 ensures reliable transport of encrypted payloads and supports socket-based communication initiated by HIM 420.

Network layer 439 operates above the datalink layer and manages the socket-level transport of messages. Network layer 439 is responsible for establishing and maintaining the connection with HIM 420, framing messages, and coordinating the flow of encrypted data to and from application 431. This layer abstracts the underlying physical transport and ensures that the TLS module and CIP engine receive well-formed, correctly sequenced data. By maintaining a persistent and secure channel, network layer 439 enables drive 430 to participate in real-time control and diagnostics while preserving protocol integrity and session continuity.

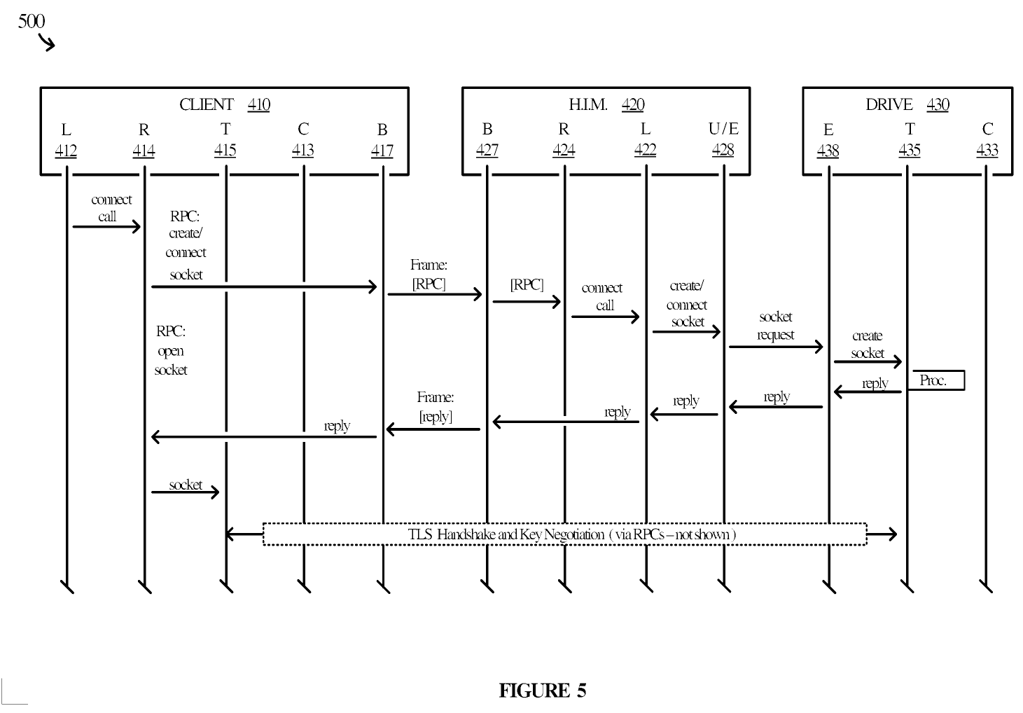

FIG. 5 illustrates operational sequence 500, which maps the secure connection setup portion of process 200 onto the specific components of environment 400, with particular emphasis on the layered interactions among client device 410, HIM 420, and drive 430. The sequence begins with BLE interface 417 in datalink layer 416 of client device 410 initiating a wireless transport channel with BLE interface 427 in datalink layer 426 of HIM 420. This BLE link serves as the physical conduit for remote procedure calls (RPCs) between the two devices, with BLE frames conforming to the Bluetooth Low Energy specification and using L2CAP for segmentation and reassembly.

Once the BLE link is active, application 411 may make a connect call to interface layer 444 to establish a connection to drive 430. RPC manager 414 within interface layer 444 of client device 410 sends an RPC message to RPC manager 424 in interface layer 421 of HIM 420. This RPC message has the connect call encapsulated within it, as well as an instruction to implement the call. Accordingly, RPC manager 424 effectively reproduces the connect call, causing interface layer 421 to create the socket and to connect the socket to drive 430 via network layer 429 and datalink layer 426.

Upon receiving the instruction, interface layer 421 creates the socket internally and connects it to drive 430 by way of a socket request. Interface layer 421 sends the socket request to drive 430 via network layer 429, datalink layer 426, and data link 403, which may be implemented using USB, Ethernet, or a USB-to-Ethernet adapter. A socket on HIM 420 and a socket on drive 430 form a bidirectional communication pair, enabling HIM 420 to send data to the socket on drive 430 and receive responses from drive 430 via its own socket. In some cases, the sockets are a combination of IP address of drive 430 (or that of any interface on the drive) and the port number for application layer Ethernet/IP protocol (e.g., 44818). The connection is instantiated over a standard TCP/IP stack, with HIM 420 encapsulating payloads into TCP segments, wrapping them in IP packets, and transmitting them as Ethernet frames through network interface 428. As may also be appreciated, the payloads may themselves be encapsulated messages (e.g., CIP messages encapsulated by EtherNet/IP).

Once the socket connection has been established, HIM 420 sends an acknowledgment back to client device 410, confirming readiness for secure session initiation. TLS module 415 of client device 410 then initiates a secure session setup by preparing a TLS handshake message. This message is encrypted and encapsulated by RPC manager 414 into an RPC payload, segmented into BLE frames, and transmitted to HIM 420. HIM 420 reassembles the RPC message, extracts the encrypted TLS payload, and forwards it using the socket to drive 430. Although drive 430 perceives HIM 420 as the immediate peer, HIM 420 acts as a transparent relay, passing encrypted handshake messages between endpoints.

During the TLS handshake, TLS module 415 and TLS module 435 perform mutual authentication using digital certificates or cryptographic tokens and negotiate a session key using a secure key exchange protocol. HIM 420 does not terminate, inspect, or modify the handshake, it simply relays the encrypted payloads over the socket pair.

Once the secure session is established, CIP engine 413 within client device 410 begins preparing encrypted CIP messages. These are encapsulated in EtherNet/IP by CIP engine 413, encrypted by TLS module 415, further encapsulated by RPC manager 414 into RPC payloads, and transmitted via BLE interface 417 to HIM 420. HIM 420 reassembles the RPC message(s), extracts the encapsulated and encrypted CIP payload, and forwards it to the socket on drive 430. Upon receipt, TLS module 435 decrypts the messages and passes the resulting CIP payloads to CIP engine 433, which interprets and executes the commands.

This sequence highlights the layered orchestration of secure communication, where client device 410 not only initiates the session but also specifies the exact socket and protocol context, ensuring that CIP over EtherNet/IP is used end-to-end. The socket pair enables directional message flow, with HIM 420 transmitting encrypted control messages to drive 430 and receiving responses over the same secure channel. HIM 420 serves as a protocol-transparent relay, enabling secure, authenticated, and application-aware communication between client device 410 and drive 430.

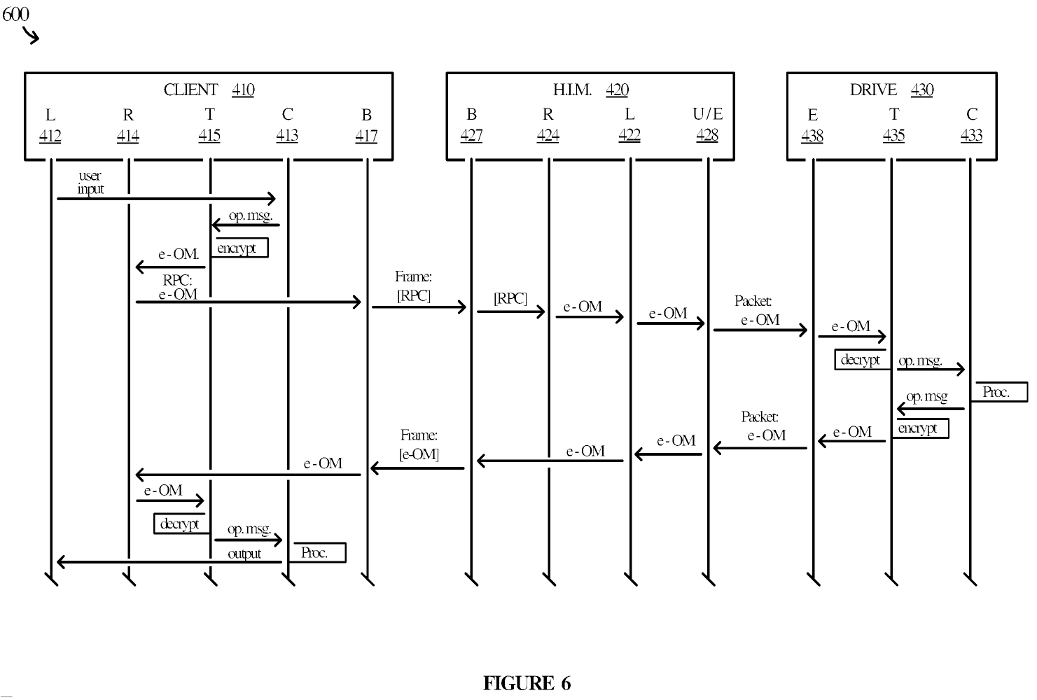

FIG. 6 illustrates operational sequence 600, which builds upon the secure session established in FIG. 5 to demonstrate the runtime exchange of encapsulated and encrypted CIP messages between client device 410 and drive 430, relayed transparently through HIM 420. The sequence begins with CIP engine 413 within client device 410 generating a control message, such as a parameter read/write or motion command, formatted according to the CIP over EtherNet/IP protocol. This CIP message is passed to TLS module 415, which encrypts the payload using the session key negotiated during the TLS handshake. The encrypted CIP message, which may also be encapsulated in EtherNet/IP, is then encapsulated by RPC manager 414 into an RPC payload, which is segmented into BLE frames by BLE interface 417. These frames conform to the Bluetooth Low Energy specification and utilize L2CAP (Logical Link Control and Adaptation Protocol) for fragmentation and reassembly.

The BLE frames are transmitted wirelessly to HIM 420, where BLE interface 427 reassembles the RPC message. RPC manager 424 extracts the encapsulated and encrypted CIP payload and forwards it to network layer 429. At this point, network layer 429 encapsulates the payload into a TCP segment, wraps it in an IP packet, and transmits it as an Ethernet frame via network interface 428. These frames traverse data link 403 and are received by network interface 438 of drive 430,

The TCP/IP stack within drive 430 processes the incoming packet, and TLS module 435 extracts and decrypts the payload, passing the resulting CIP message to CIP engine 433 for interpretation and execution. The response from drive 430 follows the reverse path: CIP engine 433 generates a response message, which is encapsulated in EtherNet/IP and encrypted by TLS module 435. The encrypted payload is encapsulated into TCP/IP packets and Ethernet frames, sent back to HIM 420, and received at the designated socket. HIM 420 forwards the encrypted payload via BLE RPC to client device 410, where BLE interface 417 reassembles the RPC message and TLS module 415 decrypts the response, allowing CIP engine 413 to process the result.

This sequence highlights the layered encapsulation strategy and socket-level coordination that ensures secure, end-to-end communication. On the client side, encrypted CIP messages are encapsulated in EtherNet/IP, then further encapsulated within RPC payloads, and transmitted over BLE. On the drive side, the same encrypted payloads are encapsulated within TCP/IP packets and Ethernet frames, as well as encapsulated within EtherNet/IP, and exchanged between the socket on HIM 420 and the socket on drive 430. HIM 420 functions as a protocol-transparent relay, preserving the confidentiality, integrity, and directional flow of control messages throughout the exchange.

Various technical effects may be appreciated from the foregoing disclosure. For example, transporting BSD Socket API as RPC over non-Ethernet channels allows developers not to change their socket-oriented programs and allows secure layers (TLS, DTLS), to be used in communications. More specially, the solutions disclosed herein enable applications to use the standard BSD socket API (or its equivalents) without modification, while the underlying implementation translates those calls into RPC messages when needed. This allows client software to interact with remote device firmware (e.g., a HIM) as if it were using local sockets. For example, the socket() component creates a virtual socket locally and sends an RPC to allocate resources remotely; connect() may initiate a TCP handshake or set filtering rules; send() transmits data and triggers TLS handshakes; select() waits locally for data availability; and recv() pulls data from the remote device via RPC. The user sees a familiar socket interface, but the actual communication and protocol handling are abstracted and managed behind the scenes, enabling seamless integration with various EtherNet/IP configurations (e.g., secure/non-secure, TCP/UDP, TLS/DTLS) without changing application code.

FIG. 7 illustrates computing device 701 that is representative of any system or collection of systems in which the various processes, programs, services, and scenarios disclosed herein may be implemented. Examples of computing device 701 include, but are not limited to, mobile phones, tablet computers, desktop and laptop computers, wearable devices, and the like. Examples also include microcontroller units (MCUs), server computers, web servers, cloud computing platforms, and data center equipment, as well as any other type of computing equipment, variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709. Processing system 702 is operatively coupled with storage system 703, communication interface system 707, and user interface system 709.

Processing system 702 loads and executes software 705 from storage system 703. Software 705 includes and implements process 706, which is representative of process 200. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, digital signal processors, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including process 706) may be implemented in program instructions and among other functions may, when executed by processing system 702, direct processing system 702 to operate as described with respect to the various operational scenarios, sequences, and processes illustrated herein. For example, software 705 may include program instructions for implementing the secure communication processes described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to perform secure communications in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, short-range communication links, point-to-point links, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the disclosed technology may be embodied as a system, method or computer program product. Accordingly, aspects of the disclosed technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the disclosed technology may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number, respectively. The word "or," in reference to a list of two or more items, covers all of the following interpretations of the word: any of the items in the list, all of the items in the list, and any combination of the items in the list.

The phrases "in some embodiments," "according to some embodiments," "in the embodiments shown," "in other embodiments," and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples of the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for” but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. One or more computer readable storage media having program instructions stored thereon for providing secure communications in an industrial automation environment, wherein the program instructions, when executed by one or more processors of a computing device, direct the computing device to at least:
establish a first data link with a human interface module (HIM) device in the industrial automation environment;
instruct the HIM device to create a socket and to connect the socket to an automation device in the industrial automation environment, wherein the industrial automation device is connected to the HIM device by a second data link;
further instruct the HIM device to forward session setup messages for a secure session over the second data link to the automation device;
process operational messages associated with an industrial communication protocol using a key associated with the secure sessionto generate secure messages; and
further instruct the HIM device over the first data link to forward the secure messages over the second data link to the socket on the automation device.

2. The one or more computer readable storage media of claim 1 wherein, to instruct the HIM device over the first data link to forward the session setup messages to the automation device, the program instructions direct the computing device to encapsulate the session setup messages in remote procedure call (RPC) messages that include instructions to send the session setup messages to the socket opened on the automation device.

3. The one or more computer readable storage media of claim 1 wherein, to instruct the HIM device over the first data link to forward the secure messages to the automation device, the program instructions direct the computing device to encapsulate the secure messages in remote procedure call (RPC) messages that include instructions to send the secure messages to the socket connected to the automation device.

4. The one or more computer readable storage media of claim 1 wherein the secure session comprises a Transport Layer Security (TLS) session, and wherein the operational messages comprise Common Industrial Protocol (CIP) messages.

5. The one or more computer readable storage media of claim 4 wherein, to establish the secure session with the automation device, the program instructions direct the computing device to perform a TLS handshake with the automation device.

6. The one or more computer readable storage media of claim 5 wherein the first data link comprises a Bluetooth Low Energy (BLE) link and the second data link comprises one or more of a Universal Serial Bus (USB) link and an Ethernet link.

7. The one or more computer readable storage media of claim 6 wherein the socket connected to the automation device comprises a network address of the automation device and a port associated with an application layer protocol, and wherein the application layer protocol is EtherNet/IP.

8. A method for securing communications end-to-end in an industrial automation environment, the method comprising,
by a first device in the industrial automation environment:
establishing a first data link with a second device in the industrial automation environment;
instructing the second device to create a socket and to connect the socket to a third device in the industrial automation environment;
securing operational messages, associated with an industrial communication protocol, using a cryptographic key associated with a secure session established between the first device and the third device, resulting in secure messages; and
sending the secure messages to the third device, including by instructing the second device over the first data link to forward the secure messages over a second data link to the socket opened on the third device.

9. The method of claim 8 further comprising, by the first device, establishing the secure session with the third device, including by instructing the second device over the first data link to forward session setup messages for the secure session to the socket opened on the third device.

10. The method of claim 9 further comprising, by the second device in the industrial automation environment:
receiving the session setup messages over the first data link from the first device and responsively sending the session setup messages over a second data link to the third device; and
receiving the secure messages over the first data link from the first device and responsively sending the secure messages over the second data link to the socket opened on the third device.

11. The method of claim 10 further comprising, by the third device: receiving the secure messages sent by the first device, decrypting the secure messages using the cryptographic key to obtain the operational messages, and replying to the operational messages in accordance with the industrial communication protocol.

12. The method of claim 11 wherein instructing the second device over the first data link to forward the session setup messages to the third device comprises, by the first device, encapsulating the session setup messages in remote procedure call (RPC) messages, wherein the RPC messages direct the second device to forward the session setup messages to the third device.

13. The method of claim 11 wherein instructing the second device over the first data link to forward the secure messages to the third device comprises, by the first device, encapsulating the secure messages in remote procedure call (RPC) messages that direct the second device to forward the secure messages to the third device.

14. The method of claim 11 wherein the secure session comprises a Transport Layer Security (TLS) session, wherein the operational messages comprise Common Industrial Protocol (CIP) messages, and wherein establishing the secure session with the third device comprises, by the first device, performing a TLS handshake with the third device.

15. The method of claim 14 wherein the first data link comprises a Bluetooth Low Energy (BLE) link and the second data link comprises one or more of a Universal Serial Bus (USB) link and an Ethernet link, and wherein the first device comprises a mobile communication device, the second device comprises a Human Interface Module (HIM), and the third device comprises a drive.

16. The method of claim 15 wherein the socket comprises a network address of the drive and a port associated with an application layer protocol, and wherein the application layer protocol is EtherNet/IP.

17. A computing apparatus comprising:
one or more computer readable storage media;
one or more processors operatively coupled with the one or more computer readable storage media; and
program instructions stored on the one or more computer readable storage media for securing communications end-to-end in an industrial automation environment, wherein the program instructions, when executed by the one or more processors, direct the computing apparatus to at least:
establish a first data link with an end-point in the industrial automation environment;
establish a second data link with an automation device in the industrial automation environment;
receive a first remote procedure call (RPC) message over the first data link from the
end-point, wherein the first RPC message includes a request from by the end-point to establish a secure session with the automation device and an instruction to forward the request to the automation device;
responsively send the request over the second data link to the automation device;
receive a second RPC message over the first data link from the end-point, wherein the second RPC message includes an operational message secured using a cryptographic key associated with the secure session and includes an instruction to forward the operational message to the automation device using a socket associated with the secure session; and
responsively send the operational message over the second data link on the specified socket to the automation device.

18. The computing apparatus of claim 17 wherein the secure session comprises a Transport Layer Security (TLS) session, and wherein the operational message comprises a Common Industrial Protocol (CIP) message.

19. The computing apparatus of claim 18 wherein the first data link comprises a Bluetooth Low Energy (BLE) link and the second data link comprises one or more of a Universal Serial Bus (USB) link and an Ethernet link.

20. The computing apparatus of claim 19 wherein the socket associated with the secure session comprises a network address of the automation device and a port associated with an application layer protocol, and wherein the application layer protocol is EtherNet/IP.
